(19) United States
(12) Patent Application Publication
(10) Pub. No.: US 2001/0041072 A1
(43) Pub. Date: Nov. 15, 2001

(54) Photo-service system and image input apparatus

(75) Inventor: Hiroaki Takano, Tokyo (JP)

Correspondence Address: FRISHAUF, HOLTZ, GOODMAN &, LANGER & CHICK, PC, 767 THIRD AVENUE, 25TH AVE, NEW YORK, NY, 10017-2023, US

(73) Assignee: Konica Corporation, Tokyo (JP)

(21) Appl. No.: 09/844,344

(22) Filed: Apr. 27, 2001

(30) Foreign Application Priority Data
May 11, 2000 (JP) 138196/2000

(51) Int. Cl. G03B 17/48

(52) U.S. Cl. 396/429

(57) ABSTRACT

A photographic service system comprising: at least one or more of an image input apparatus including a receiver for receiving an order by itself (without a dedicated operator), a processor for photographic-processing a silver halide photographic light-sensitive material, a converter for converting image recording information of the silver halide photographic light-sensitive material after the photographic processing into digital image data through an image sensor, and issuing device for issuing an ID for retrieving digital image data and an index print after receiving an order; and an image server including a communication device for communicating with the image input apparatus through a network and a giving device for giving the ID for retrieving digital image data to the digital image data transferred from the image input apparatus and for storing the digital image data.

### BACKGROUND OF THE INVENTION

This invention relates to a photo-service system and an image input apparatus for providing a new photographic service utilizing a network, for a customer who utilizes a self-service apparatus, which photographic-processes an exposed silver halide photographic light-sensitive material and converts the visualized image recording information into digital image data through an image sensor.

The photographic light-sensitive material utilizing silver halide has developed more and more in recent years, and at present, it is possible to obtain a color photograph of high image quality simply. For example, in a method usually called color photography, a color print can be obtained by making a shot using a silver halide color photographic light-sensitive material (hereinafter, referred to as simply “a color negative film, or a film”) and optically printing the image information, which is recorded on the film after processing, on a sheet of color photographic paper. In recent years, this process has highly developed, and owing to the spread of laboratories, which are large-scale concentrated base sites for producing mass color prints at a high efficiency, and so called mini-laboratories, which are small-sized simple printer-processors installed in shops, it has become possible that every one enjoys color photography easily.

In recent years, owing to the spread of personal computers and a memory medium (hereinafter referred to also as “a memory”) being made to have a higher density, it is increasing the opportunity such that digital image data, which has been obtained by using an apparatus for converting image recording information of a photographic-processed color negative film into an electrical signal (hereinafter referred to as “a film scanner”) through an image sensor (herein after referred to simply as a “CCD”), is outputted to a color photographic paper or another material.

In place of a conventional camera using a film (hereinafter referred to as “an analogue camera”), digital cameras have rapidly spread which convert an analogue signal into a digital signal as electronic image information using the aforesaid CCD and output it to a memory medium. Lately, accompanied by it that the image sensor having a large number of pixels is made to have a smaller size and a lower price, it has been put on the market an apparatus provided with a function to enable the appreciation of image information by outputting it to an instant film as a hard copy immediately after photographing (hereinafter referred to as “a digital camera printer”).

As described in the above, there are various kinds of photographic systems on the market, and each of them has an advantage and a disadvantage, but all of them should equally respond to the requirement for simplicity.

For an analogue camera using a color negative film, the technology to make it of small size, of light weight, and automatic has developed, and further, an improvement for portability and convenience has been progressing; for example, even a throwaway camera (called also “a single-use camera”) has been brought into practice. However, it is difficult to accomplish instantaneousness equivalent to an instant film capable of appreciating an image immediately after photographing or a liquid crystal monitor of a digital camera. Further, also in order to obtain digital image data by using the above-mentioned film scanner, it is necessary once to request photographic processing to a laboratory; above all, it can not be regarded as excellent in convenience, because it is necessary that a customer purchases a high-priced apparatus, sets a film, and sets reading conditions for himself, for example.

On the other hand, with an instant film a user can appreciate an image immediately after a shot; however, photographic-processing is to be carried out by ejecting the film to the outside of the camera, and the film after photographic processing as it is becomes the print to appreciate; therefore, reading it by a film scanner is more troublesome than a color negative film.

As described in the above, a digital camera is excellent because a user can appreciate an image by a liquid crystal monitor immediately after photographing and digital image data, and also a hard copy to speak of the above-mentioned digital camera printer, can be simply obtained on the spot. However, as compared to a color negative film or an instant film, there are such problems that it has a limit in making the size of the apparatus small and that its electric power consumption is large. Further, in order to obtain high quality images by a digital camera, a large amount of memory capacity is required. Thus, in order to take a large number of pictures during a travel, there has been a problem that it is necessary to prepare a large number of exclusive and very expensive memory media capable of connecting with the digital camera.

The requirements for the photographic systems can be mainly summarized into three items; that is, it can be said that the first one is to improve the portability of the camera for photographing more and more, the second one is to make photographic processing simple (instantaneousness), and the third one is to cope with digital outputting (non-silver-halide printer).

### SUMMARY OF THE INVENTION

This invention has been made mainly in view of the above-mentioned first to third requirements, and it is an object of it to build up a photo-service system and an image input apparatus for providing a multiplex photographic service composed of a service of keeping digital image data, a service for perusing digital image data, a service of providing digital image data, and a service of receiving an order for a digital print, by combining a self-service (unmanned) image input apparatus, which photographic-processes an exposed color negative film and converts the visualized image recording information into digital image data through an image sensor, with a network.

The above-mentioned requirements can be solved by any one of the following structures 1 to 13.

Structure 1: A photo-service system comprising: at least one or more of an image input apparatus comprising means for receiving an order by itself (without a dedicated operator), means for photographic-processing a silver halide photographic light-sensitive material, means for converting image recording information of said silver halide photographic light-sensitive material after the photographic processing into digital image data through an image sensor, and means for issuing an ID for retrieving digital image data and an index print after receiving an order; and an image server comprising means for communicating with said image input apparatus through a network and means for giving the ID for retrieving digital image data to the digital image data transferred from said image input apparatus and for storing the digital image data.

Structure 2: The photo-service system described in the structure 1, which is characterized in that at least one of said image input apparatus comprises means for capturing the digital image data from said image server by inputting said ID for retrieving, and means for storing the captured image data in an external memory medium capable of being dismounted.

Structure 3: The photo-service system described in the structure 1, which is characterized in further comprising a client computer having means for communicating with said image server through a network, wherein said image input apparatus comprises means for issuing, after receiving an order, a home page address, an ID for retrieving digital image data and an index print, means for enabling an operator to read the digital data by inputting the ID for retrieving digital image data while said client computer is communicated with said image server through the network, and means for storing the digital image data into a memory medium of said client computer.

Structure 4: The photo-service system described in the structure 1, which is characterized in that said image input apparatus comprises means for receiving an order for producing a digital print, means for issuing, after receiving an order, an ID for retrieving digital image data, means for preparing an order data file in which the content of said order for the digital print and said ID for retrieving are recorded, and means for transferring said order data file in the state of being separated from digital image data to said image server, said image input apparatus further comprising means for reading out said order data file and digital image data from said image server on the basis of the ID for retrieving recorded in said order data file, and means for producing a digital print on the basis of said order data file.

Structure 5: The photo-service system described in the structure 1, which is characterized in further comprising means for producing a digital print from the digital image data stored in said image server, wherein said image input apparatus comprises means for issuing an order form with an index print attached in which a column to be filled with an order for the digital print and an ID for retrieving digital image data are described.

Structure 6: The photo-service system described in the structure 1, which is characterized in that said image input apparatus comprises means for issuing an order form with an index print attached in which a column to be filled with an order for a digital print, an ID for retrieving digital image data, and at least one of a telephone number and a facsimile number are described.

Structure 7: The photo-service system described in the structure 1, which is characterized in further comprising means for producing a digital print from digital image data stored in said image server, wherein said image input apparatus comprises means for issuing an order form with an index print and an ID for retrieving digital image data attached in which an order for producing the digital print is described.

Structure 8: The photo-service system described in the structure 3, which is characterized in that the client computer is further able to make an order for producing a digital print.

Structure 9: The photo-service system described in the structure 1, which is characterized in that at least two or more of said image input apparatus are provided.

Structure 10: An image input apparatus comprising means for receiving an order by itself (without a dedicated operator), means for photographic-processing a silver halide photographic light-sensitive material, means for converting image recording information of said silver halide photographic light-sensitive material after the photographic processing into digital image data through an image sensor, and means for issuing a specified form in which an ID for retrieving a digital image is described.

Structure 11: The image input apparatus described in the structure 10, which is characterized in further comprising means for issuing a specified form in which a home page address in addition to the ID for retrieving a digital image is described.

Structure 12: The image input apparatus described in the structure 11, which is characterized in further comprising means for issuing a specified form in which a index print in addition to the ID for retrieving a digital image and the home page address is described.

Structure 13: The image input apparatus described in the structure 12, which is characterized in that the specified form has a magnetic layer for recording information, and order data is recorded in said magnetic recording layer.

### BRIEF DESCRIPTION OF THE DRAWINGS

FIG. 1 is a drawing of the whole of a photo-service system “d” of this invention;

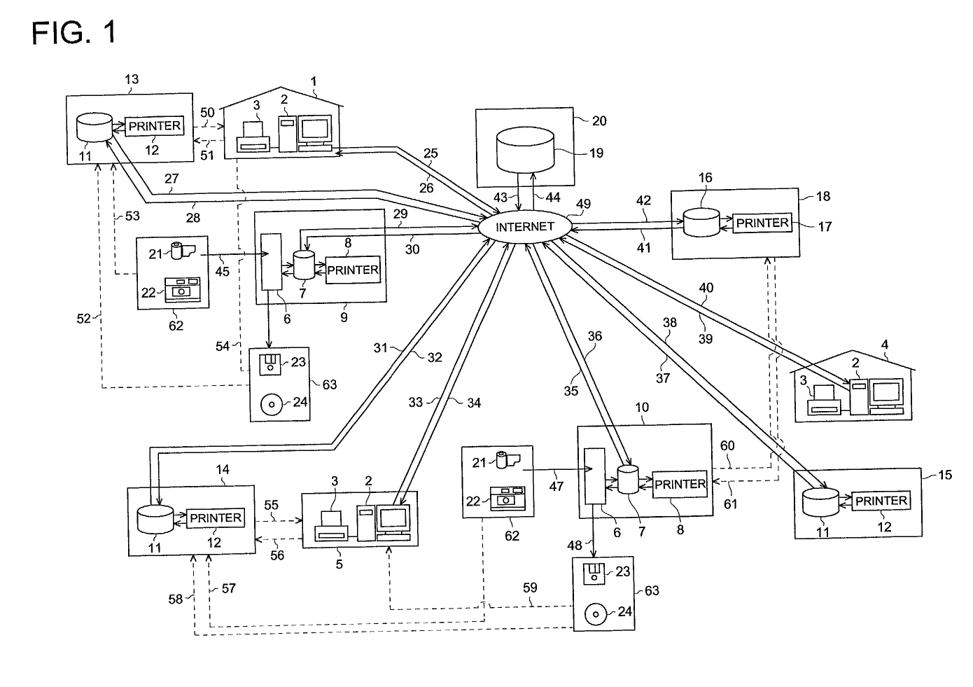

FIG. 2 is an illustration of a photo-service system consisting of a store having an image input apparatus installed, a service center having an image server installed, a mini-laboratory shop, and a usual home;

FIG. 3 is an illustration of a photo-service system consisting of a store having an image input apparatus installed, a collecting delivering laboratory, a mini-laboratory shop, and a usual home;

FIG. 4 is an illustration of a photo-service system consisting of a store having an image input apparatus installed, a service center having an image server installed, a collecting delivering laboratory, and a usual home;

FIG. 5 is an illustration of a photo-service system consisting of a store having an image input apparatus installed, a collecting delivering laboratory, and a usual home;

FIG. 6 is an illustration of a photo-service system consisting of a store having an image input apparatus installed, a service center having an image server installed, a collecting delivering laboratory, and a usual home;

FIG. 7 is an illustration of a photo-service system consisting of a store having an image input apparatus installed, a service center having an image server installed, a mini-laboratory shop, and a usual home;

FIG. 8 is an illustration of a photo-service system consisting of a store having an image input apparatus installed, a collecting delivering laboratory, a mini-laboratory shop, and a usual home;

FIG. 9 is an illustration of a photo-service system consisting of a store having an image input apparatus installed, a service center having an image server installed, a usual home (a customer's home), a usual home (home of a customer's friend), and an office;

FIG. 10 is an illustration of a photo-service system consisting of a store having an image input apparatus installed, a usual home (a customer's home), a usual home (home of a customer's friend), an office, and a collecting delivering laboratory;

FIG. 11 is an illustration of a photo-service system consisting of a store having an image input apparatus installed, a service center having an image server installed, a usual home (a customer's home), a usual home (home of a customer's friend), an office, and a mini-laboratory shop;

FIG. 12 is a drawing showing the processing flow 1 of an image input apparatus;

FIG. 13 is a drawing showing the processing flow 2 of an image input apparatus;

FIG. 14 is a drawing showing the processing flow 3 of an image input apparatus;

FIG. 15 is a drawing showing the processing flow 4 of an image input apparatus;

FIG. 16 is a drawing showing the processing flow 5 of an image input apparatus;

FIG. 17 is a perspective view showing the outline of an image input apparatus; and

FIG. 18 is a drawing showing the outline of an index print.

### DETAILED DESCRIPTION OF THE PREFERRED EMBODIMENT

In the following, this invention will be explained in detail.

“A silver halide color photographic light-sensitive material” used in this invention means, for example, a color negative film which is known as a conventional photographic film, and a color negative film put on the market etc. can be cited.

Further, with respect to an image input apparatus used in a photo-service system of this invention, it is desirable that the apparatus has a structure such that if a customer only put in a housing member (hereinafter referred to as “a cartridge”) in which the above-mentioned color negative film is housed, or a camera of a throwaway type as it is, photographic processing and acquisition of digital image data can be practiced, because collection of waste material can be carried out efficiently.

Further, in this invention, it may be used suitably also a photographic film which is designed only for being read by a film scanner, for which it is not taken as a premise to produce a photographic print by projecting an exposure light to a photographic paper using an analogue printer, as is done for the above-mentioned conventional photographic film.

For such a silver halide photographic light-sensitive material, for example, as described in the Japanese publication of the unexamined patent application 2000-310840, it can be cited one of such a type as to have a photosensitive layer capable of recording luminous component information, or desirably, further to have a photosensitive layer capable of recording color information independently.

For “means for carry out photographic-processing”, any type of the following may be appropriately used, that is, liquid photographic-processing mechanism called “C-41 process” used in usual processing for a color negative film, a mechanism based on a processing-processing method disclosed in WO98/19216, and thermal photographic-processing mechanism in which a color negative film is pasted with a processing sheet containing a processing agent after swelling by water, and is pressed by a heat block or a drum to be treated by heating. In this invention, it is desirable to use the last-mentioned thermal photographic-processing mechanism for the reasons that the apparatus can be made small, that waste liquid of processing is of small amount, and that maintenance can be simplified.

It is desirable that the photographic-processing used in this invention is such one as to end in a state of unfinished desilvering process, in other words, to make the bleaching and fixing processes end in an incomplete state or a state of being not performed at all. It is desirable to practice the method described in the Japanese publication of the unexamined patent application 2000-310840 together with the above-mentioned process, in order to improve the deterioration of image quality resulted from it that the metallic silver produced by processing (developed silver) and the non-reacted silver halide are remaining.

An “image sensor” means a light receiving device converting an amount of optical energy per unit time projected on a specified surface area into an electrical signal (also called “an image input medium” or simply “a CCD”). As an example of this device, a device of such a type as one-dimensional line sensor with monochromatic (having no capability of color discrimination) CCD pixels having sensitivity in visible optical wavelength region or in a region extended to infrared region arrayed in a line, or an area sensor with monochromatic CCD pixels arrayed two-dimensionally lengthwise and breadthwise can be cited.

“To convert into digital image data” means to obtain color-separated image information of three original colors of red, green, and blue, which is color (image) information of a photographic object recorded in a color negative film, by using the above-mentioned “image sensor”. For such “means”, it is known a “film scanner unit” having a function to obtain sequentially color-separated image information through the application of a transmitting light, by scanning a film for which photographic processing has been finished in a constant direction.

Further, it is also possible to carry out the reading using a reflecting light as disclosed in the above-mentioned publication WO98/19216, or the reading using an infrared light.

A “recording medium” means a rewritable memory which represents a means for storing electronic files or image data, so called a hard disk. In a general embodiment, the “recording medium” is fixed and installed inside the “image input apparatus” of the present invention. In addition, there is an another embodiment in which the “recording medium” is installed in the server in the case where the “image input apparatus” is provided with a sever function outside the “image input apparatus”.

“Means for receiving an order by itself (without a dedicated operator)” in this invention means a mechanism for a guide conveying how to operate the apparatus by letters or voice, a mechanism for automatically collecting the charge, etc.

“Image input apparatus” in this invention means an apparatus which is equipped with the above-mentioned means for receiving an order by itself (without a dedicated operator), photographic-processes a silver halide color photographic light-sensitive material and converts an image into digital image data through an image sensor.

“Means for communicating through a network” in a photo-service system of this invention means such ones that are necessary in utilizing an existing network by using a personal computer such as a device called a “modem”, an application software, and a connection trader called a “provider” who connects a telephone line to the Internet line, for example.

An “image server” means an apparatus provided with the aforesaid “memory medium” having a capacity enough to store a large amount of high-resolution image data, what is called a hard disk.

“Means for issuing an ID for retrieving” means a mechanism for recording information by exposure, printing, magnetic recording, writing in a memory medium, or the like. For example, in the case of exposure, it can be cited an optical scanning exposure method using an LED light source for an instant film. It may be a printing method using an ink jet paper, or a method in which a magnetic information recording layer is provided on an output material such as a paper or plastic sheet and writing by a magnetic head is carried out.

In addition, in the case where the above-mentioned magnetic information recording layer is provided, a printing section is provided in order to make it possible to read visually an ID for retrieving, and a reader section for reading magnetic information is provided in each of the image input apparatus and the means for producing digital prints to be described later.

An “detachable external memory medium” means a memory (a medium) which has a comparatively large capacity and is capable of storing digital image data such as a “CD-R” or an “MO”, and it may be either of a rewritable type or of a writing once (non-rewritable) type.

A “client computer” in this invention is a computer which is capable of being connected to The Internet and is owned by a customer, or a friend or an acquaintance of a customer, or is installed in an office etc., and it is used in an order for digital printing from a home page.

“Perusing digital image data” means appreciating image data etc. by connecting the above-mentioned client computer to The Internet and using a software for perusing a home page (a browser).

“Means for producing a digital print” means an apparatus which forms a visible image from digital image data on an output material such as a sheet of photographic paper or an ink jet paper, and for such an apparatus, the QD-21 model manufactured by Konica corp. is known.

A “home page address” means a name indicating the whereabouts of a home page to input in the software for perusing a home page (a browser) at the time of the above-mentioned “perusing digital image data”.

An “ID for retrieving” means such one that is attached for identifying a group of digital image data and is composed of numerals, characters of an alphabet for example, and a symbol of six figures inclusively. For example, it is made as “urq@12”.

An “index print” means a print of a list of images from digital image data.

An “order form with an index print attached” in this invention means such one that is composed of an index print on which a list of images from digital image data are outputted and an order form provided with a column for entering an order, separated from the above-mentioned “ID for retrieving”. The above-mentioned order form with an index print attached may be of such a type that it is processed in such a way that they may be separated by a perforation or the like, either one is pasted as a seal, or an order column is provided for each of printed image frames.

This invention as set forth in the structure 1 is characterized by it that an image input apparatus and an image server are in the state capable of communicating with each other through The Internet, and, in order to make it possible to use digital image data stored in an image server commonly for an retrieval from an image input apparatus installed in any one of stores, an ID for retrieval is attached. According to the present invention described in structure 2, if a customer keeps an ID number for retrieving which is issued by an image input apparatus, he can obtain a medium in which image information is recorded at another store. Moreover, it is desirable that an image input apparatus issues a print of an image list from digital image data together with an ID for retrieval, because a customer can confirm the situation of photographing and if the processing has been carried out correctly.

This invention as set forth in the structure 3 is characterized by it that, on top of an image input apparatus and an image server described in the structure 1, it is further provided with a client computer which is capable of mutually communicating with an image server. Further, in the structure 3, it is issued an index print in which an ID for retrieving digital image data and a home page address are noted.

For example, a customer can appreciate images from digital image data, by accessing the home page address immediately after he returns home or at a position where a computer that a customer can use is installed and inputting the ID number for retrieving.

Further, by conveying the home page address and the ID number for retrieving image data to his friend or his company orally or by a letter, telephone, fax, electronic mail or the like, it becomes possible to peruse digital image data by a computer at the home of his friend or a computer at his office.

Further, by designating all or a part of a list of preview images from digital image data displayed by using a browser, a customer can store the digital image data in an internal memory medium of the client computer or in an external memory medium.

This invention as set forth in the structure 4 is characterized by it that a store capable of mutually communicating with an image server is added to the system on top of a store, in which an image input apparatus of the above-mentioned structure 1 further having a function to receive an order for digital printing, and an image server. Therefore, because a customer, using said image input apparatus, can make an order for digital printing, he need not to enter an order form at a storefront, while the store acquires an order file, which has been prepared by the customer and has the aforesaid ID for retrieving recorded on it, and digital image data from an image server, and produces digital prints on the basis of the order file. The produced prints are delivered to a specified place which has been designated at the time of order such as his home, home of his friend, or his office by mail or by home delivery service.

This invention as set forth in the structure 5 is characterized by it that a store capable of mutually communicating with an image server is added to the system on top of a store, in which an image input apparatus of the above-mentioned structure 1 capable of issuing an index print having a column for entering an order for digital printing, and an image server. Therefore, a customer notes the predetermined items such as the frame number to print, the number of prints, and the size, and visits the store. The store, receiving the index print order form which the customer has brought, acquires digital image data from the image server on the basis of the ID for retrieving, and produces digital prints on the basis of the order data noted. The produced prints can be received immediately on the spot.

This invention as set forth in the structure 6 is characterized by it that, in the structure 5, a telephone number or a fax number is noted in the index print which the image input apparatus produces. Owing to this, directly without visiting a store, a customer can make an order for digital printing by telephone or by fax.

This invention as set forth in the structure 7 is characterized by it that the image input apparatus of the structure 5 is provided with a function capable of noting an order for digital printing. As described in the above, this writing of order data may be done not only by printing but also by recording an invisible information such as magnetic information recording. Owing to this, order data can be read by a magnetic card reader installed at the storefront of a store for example, and the read data is immediately transmitted to a digital printer, and a customer can receive digital prints on the spot.

In the structure 3, only it is possible for a customer to appreciate an image from digital image data, by accessing the home page address immediately after he returns home and inputting the ID for retrieving; however, this invention as set forth in the structure 8, is characterized by it that an order for a print can be made from on a home page.

Through designating all or a part of a list of the preview images from digital image data displayed on a monitor display by using a browser, practicing the predetermined input in columns for specifying the delivery destination of the digital prints and the way of payment (for example, payment by a credit card, or by collect on delivery, or the like) respectively, and carrying out the transmission operation of data, a customer can make an order for producing digital prints of digital image data.

### EXAMPLES

In the following, examples of practice of this invention will be explained by referring to the drawings.

Heretofore, it has been carried out by means of physical conveyance means of a customer or a photographic service trader (50 to 61 shown by the dotted lines), the conveyance of a photographic film, a memory medium in which digital image data is recorded or stored, a digital print, etc. from one to another among stores (9 and 10) such as convenience stores, usual homes (1 and 4), an office (5), mini-laboratory shops (13, 14, and 15), a service center (20), and a collecting delivering laboratory (18), which are located in a dispersed manner.

In putting a photographic service of this invention into practice, for the purpose of carrying out transmission and reception of digital image data through an electronic communication network, what is called The Internet (49), and building up a photo-service system utilizing delivery by mail or a home delivery service, arrangement of the specified apparatus is carried out. The above-mentioned specified apparatus are an image input apparatus (6) at stores such as convenience stores, a personal computer (2) at a usual home or at an office, a printer (12) for producing digital prints at a mini-laboratory shop, and an image server (19 or 16) for storing digital image data at a service center or a collecting delivering laboratory, and each of them is provided with a communication means utilizing The Internet (one of 25 to 44 shown by the solid lines).

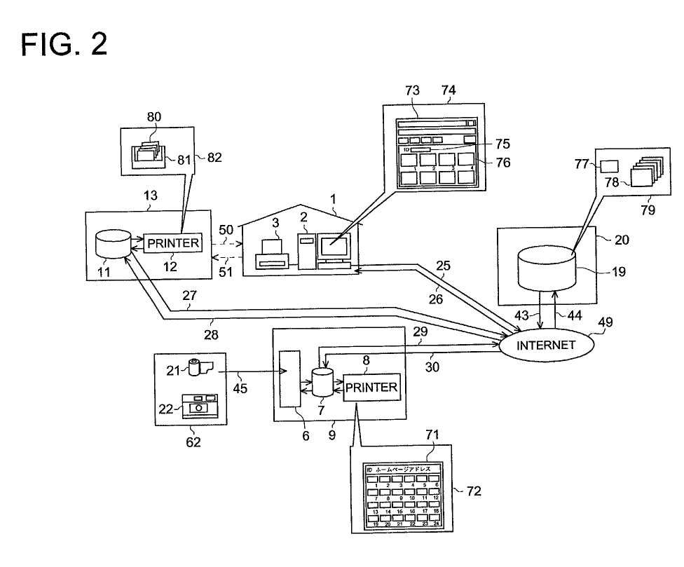

Further, as shown in FIG. 2, the image input apparatus of this invention (6) is provided with means for determining a symbol for identifying a group of digital image data, an ID number for retrieving for example, which is recognized between the image input apparatus and the image server (19) at the service center (20), and means for issuing an index print (71) having a list of hard-copied images of digital image data together with a home page address, the telephone number and the fax number of the service center noted, a column for entering an order, and a magnetic information recording layer. The embodiment will be described in detail by referring to the drawings.

When a customer is willing to keep digital image data, as shown in FIG. 2, he sets a cartridge (21), a camera for photographing (22) of a throwaway type which is loaded with said cartridge (21) beforehand, or the like in the image input apparatus of this invention (6) installed at a store (9) located at a place on his journey such as a sight seeing place (45). After completion of the specified procedures such as the designation of the service content, which will be described later in detail, and the payment of the charge, the digital image data obtained by the image input apparatus (6) is temporarily stored in an internal memory of the server (7), and then it is transmitted to the image server (19) at the service center together with a signal to request an ID number through The Internet (29 and 44). The image server 19, after judging the content of the transmitted digital image data, the other end of transmission, the transmission time, etc., stores them in a specified position (79) of the internal memory medium together with a data file (77) in which the ID number is recorded. The image input apparatus (6) receives the ID number transmitted by the image server (19) through The Internet (43 and 30), and issues a print (an index print) (71) in which the above-mentioned ID number as well as a list of hard-copied images of digital image data is recorded.

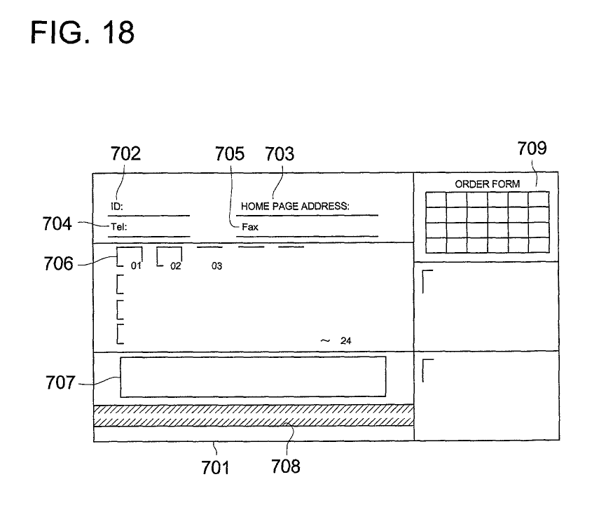

A concrete example of an index print is shown in FIG. 18; in the drawing, 701 denotes an index print, 702 denotes an ID number for retrieving, 703 denotes a home page address, 704 denotes a telephone number, 705 denotes a fax number, 706 denotes a list of digital images, 707 denotes remarks concerning the keeping of digital image data, 708 denotes a magnetic recording portion, and 709 denotes an order form.

The store (9) is desirably a convenience store or a super market which are open 24 hours every day for the reason that the time to provide services is not limited.

It is also appropriate to design the image server (19) in such a manner that the storage period of digital image data in the image server (19) is set, and on the basis of the date information in the data file (77) in which an ID number is noted, said image server (19) automatically erases data. In this case, it is desirable that the storage period of digital image data and the automatic erasing of it is clearly noted on the index print (71) or on the home page, and also such a service is done with it that the remaining number of days up to the erasing is notified by always displaying it on the home page.

Further, in order to cope with the loss of the ID number in an order which has been treated before, it is appropriate to give such a function that, if only the latest ID number is inputted, a list of the ID numbers which have been obtained before it and the data noting the remaining number of days up to the automatic erasing can be confirmed on the home page, or they are delivered by mail at every predetermined interval.

It is desirable to design the aforesaid image input apparatus (6) in such a manner that the digital image data keeping service of this invention can be utilized, after it is selected and the processing for it is done, a service not to transmit the digital image data obtained by the image input apparatus (6) through The Internet to the image server (19) but to store it in an medium, or even in the case where a medium for which the same service was once practiced is brought.

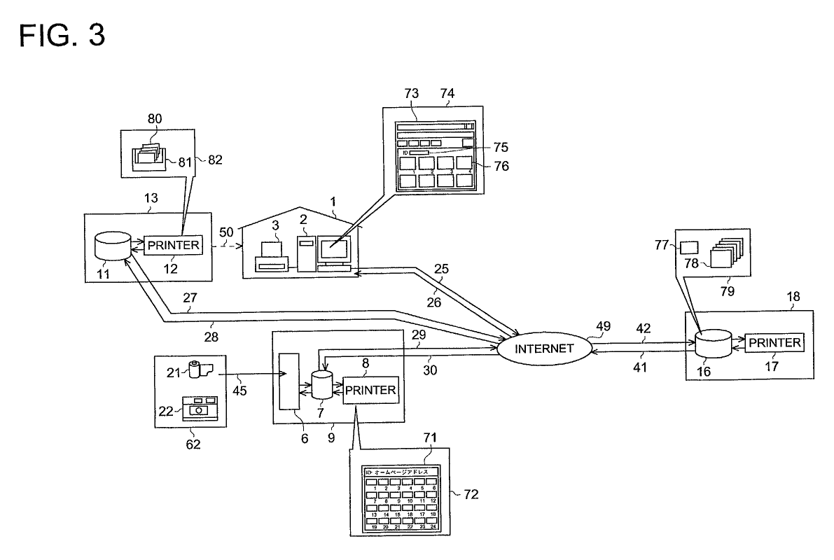

Moreover, as shown in FIG. 3, it is also appropriate that the collecting delivering laboratory (18) is made to have the function of the service center (20), and digital image data and the data file (77) are to be stored in the laboratory server (16).

Further, it is also appropriate that the function of the service center (20) or the collecting delivering laboratory (18) is united with that of the mini-laboratory shop (13) to make it have an integrated function, and digital image data and the data file (77) are stored in the laboratory server (11).

In the case where a customer wishes to peruse digital image data, as shown in FIG. 2, he makes it displayed on a screen of a browser, an application software (73) for retrieving and perusing digital image data stored in an internal memory medium of the image server (19), by accessing the home page address noted in the index print (71) using a software for perusing (a browser) (25 and 44). Next, by the input of the ID number in the column for inputting an ID number (75), the ID number is transmitted to the image server (19) through The Internet (25 and 44). The image server (19) retrieves the corresponding digital image data from the transmitted ID number, and transmits low-resolution image information (hereinafter referred to as “preview images”), which is produced by compressing the file data volume and is based upon a predetermined form, of the above-mentioned digital image data to the computer (2) (43 and 26). The above-mentioned software (73) displays the list of the preview images (76) received, and then remains in the still-standing state as it is ready for the instruction of next service.

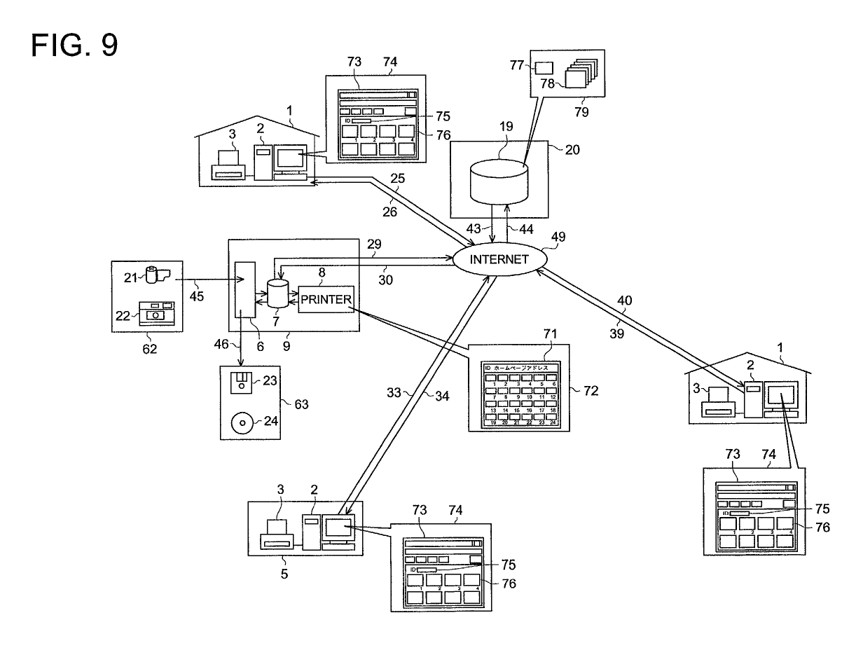

As shown in FIG. 9, by the ID number noted in the index print (71) and the home page address being conveyed orally or by a letter, telephone, fax, electronic mail, or the like to a friend or to a company, the friend or the company, using a computer (2) at the friend's home or a computer (2) at the office (5), peruses digital image data. Especially, in order to make the communication by electronic mail more efficient, it is desirable to give a function such that, when an electronic mail address of a person to whom the ID number is to be notified is inputted, an electronic mail carrying the ID number and the home page address with a simple greeting sentence attached is automatically transmitted.

In the case where a customer wishes to download digital image data, as shown in FIG. 2, by designating all or a part of a list of preview images of the digital image data (76) displayed in the software (73) by him using a browser, he can store digital image data of which the data volume is not compressed in an internal memory medium of the computer (2) or in an external memory medium.

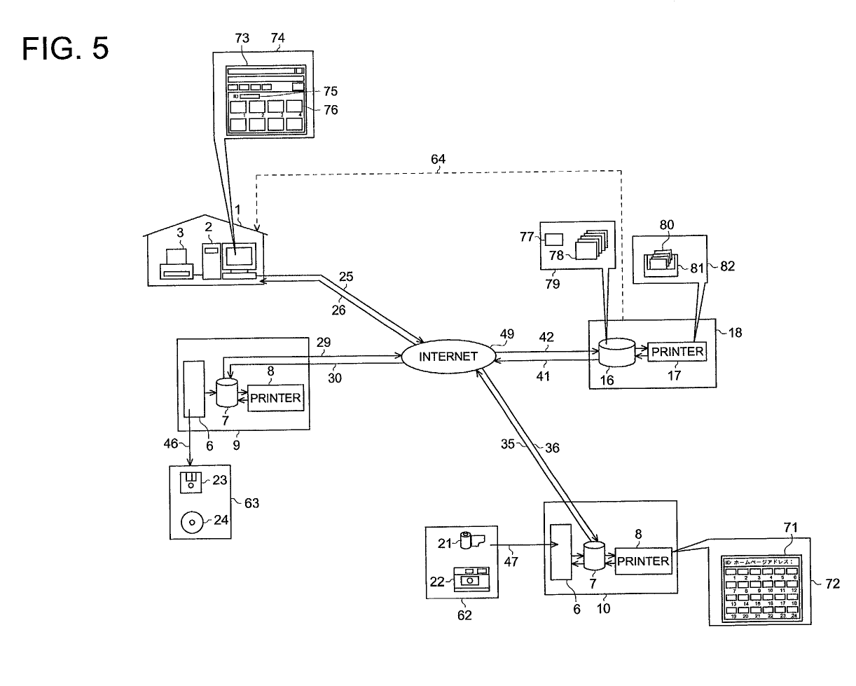

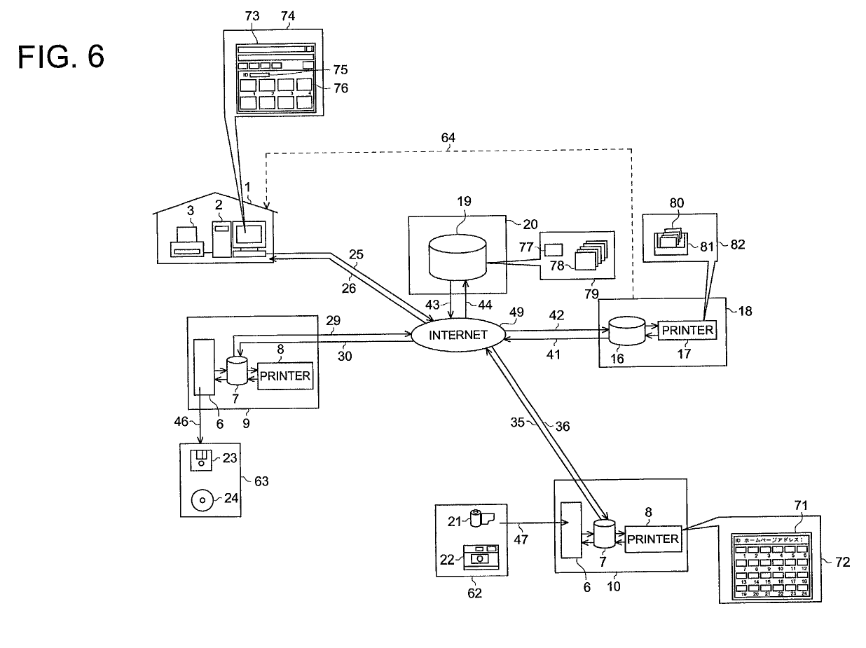

In the following, by referring to FIG. 5 and FIG. 6, the function of downloading service of the image input apparatus (6) for digital image data will be explained. It is appropriate to design the function in such a manner as follows: First, through carrying out the processing by using the image input apparatus (6) installed at a store (10) at a remote place such as a sight seeing place, a customer prepares an index print (71). Next, after returning home, or on the way of returning home, he visits the store (9) near his home, and using the image input apparatus (6) installed there, reads out digital image data stored in the laboratory server (16) of the collecting delivering laboratory (18), or in the image server (19) of the service center (20) (29 and 42, or 29 and 44) by inputting the ID number noted in the aforesaid index print (71) and receives it through The Internet (41 and 30 or 43 and 30); then, he can store the digital image data in a medium (63) sold by the image input apparatus (6).

Further, it is also appropriate to do a service of storing digital image data in accordance with the expiring time of the storage period of it or in response to the order of a customer and delivering it to him by mail or by home delivery service, together with the above-mentioned downloading service.

Further, it is given to the system a function such that, in the case where a customer wishes to make an order for digital prints, as shown in FIG. 2, by designating all or a part of a list of preview images of the digital image data (76) displayed in the software (73) by him using a browser, he can make an order for producing digital prints of the digital image data.

For example, such a function as stated in the following is given: On the aforesaid software (73), a column for noting the destination of delivering digital prints, and a column for designating the way of payment (for example, payment by a credit card, or collect on delivery) are provided, and by the practice of the transmission operation of the data after the predetermined inputting is finished, the software automatically retrieves the mini-laboratory shop (13) by taking into consideration the efficiency, the content of service, the distance to the delivery destination, etc., and the order file is transmitted to the laboratory server (11) at said mini-laboratory shop (13) through The Internet (25 and 28). In the mini-laboratory shop (13), in accordance with the content of the above-mentioned order file, the request for the transmission of the digital image data is conveyed to the image server (19) of the service center (20), together with the ID number, the certification number of the mini-laboratory shop, the date, the kind of the digital printer, etc (27 and 44). In the image server (19), the corresponding digital image data is retrieved from the transmitted ID number, and said digital image data is transmitted to the laboratory server (11) (43 and 28). The digital printer (12) reads out digital image data stored in an internal memory medium of the laboratory server (11), and produces digital prints. The produced digital prints (80), after being contained in the specified sack (81), is delivered to the address which is noted in the order file of the customer by mail, home delivery service, or the like.

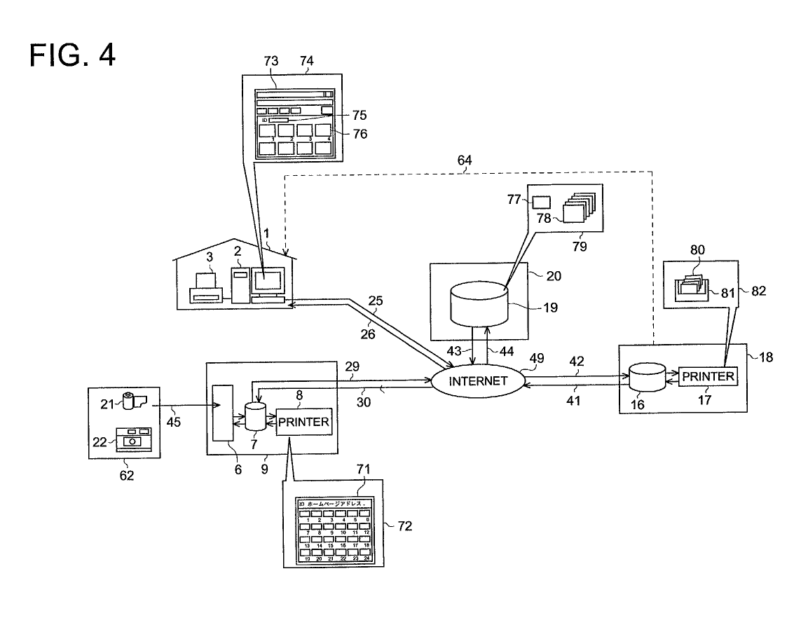

Moreover, it is also appropriate to design the system in such a manner that, as shown in FIG. 2, the order file is not transmitted to the laboratory server (11) of the mini-laboratory shop (13) through The Internet (25 and 28), but it is once transmitted to the image server (19) of the service center (20) (25 and 44), and the mini-laboratory shop (13) or the collecting delivering laboratory (18) as shown in FIG. 4 is automatically retrieved by said image server (19) on the basis of the efficiency, the content of service, the distance to the delivery destination, etc.; then, the order file and the image data are automatically transmitted to the above-mentioned laboratory server (11) of the mini-laboratory shop (13) (42 and 28).

Further, it is desirable to design the system in such a manner that, as shown in FIG. 3, in the case where the collecting delivering laboratory (18) is made to have the function of the service center (20), and digital image data and the data file (77) are stored in the laboratory server (16), it is automatically judged and instructed on the basis of the efficiency, the content of service, the distance to the delivery destination, etc. and instructed, by which one of the mini-laboratory shop (13) and the collecting delivering laboratory (18) the production of digital prints is practiced.

Further, it is also appropriate to integrate the function of the service center (20) or the collecting delivering laboratory (18) into that of the mini-laboratory shop (13), to store digital image data and the data file (77) in the laboratory server (11); in this case, the retrieval of digital image data and the transmission of said digital image data to the laboratory server (11), which have been carried out by the image server (19) in response to the request of transmission of digital image data, become unnecessary.

In the following, by referring to FIG. 5 and FIG. 6, it will be explained the method of ordering digital prints utilizing the function of downloading digital image data of the image input apparatus (6). First, a customer carries out the processing using the image input apparatus (6) installed at a store (10) in a remote place such as a sight seeing place, to produce an index print (71). Next, after returning home, or on the way of returning home, he visits the store (9) near his home, using the image input apparatus (6) installed there, reads out digital image data stored in the laboratory server (16) of the collecting delivering laboratory (18), or in the image server (19) of the service center (20) (29 and 42, or 29 and 44) through inputting the ID number noted in the aforesaid index print (71), and receives it through The Internet (41 and 30 or 43 and 30); then, he stores the digital image data in a medium (63) sold by the image input apparatus (6). Moreover, at this time, in the medium (63), a program for ordering digital prints is also stored. It is desirable that the above-mentioned program is designed to be such one as to lighten the load of transmitting data by a function for carrying out communication automatically without manually inputting the ID number noted in the index print (71) and the home page address, a display function for using simultaneously also digital image data stored in the medium (63), etc.

It is also appropriate to make it possible that a customer brings back the medium in which the digital image data and the program for ordering digital prints are stored, and makes an order for digital printing using the computer (2) at his home (1).

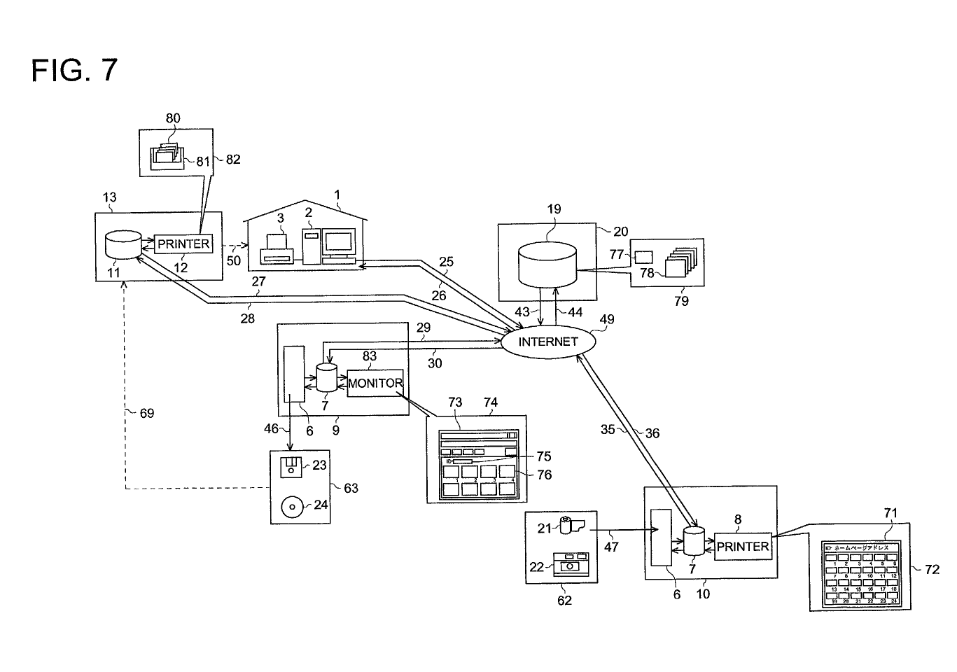

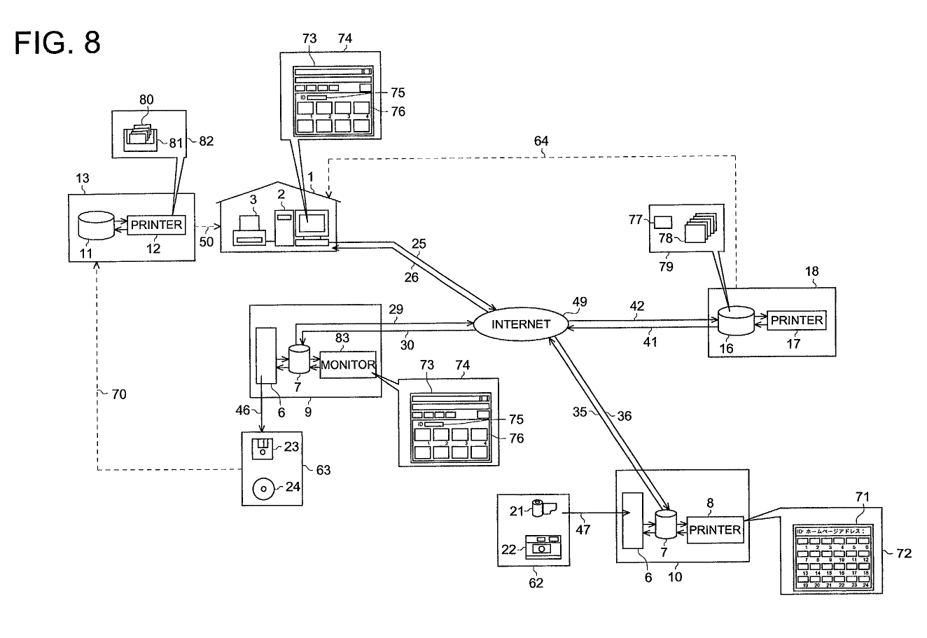

In the following, by referring to FIG. 7 and FIG. 8, it will be explained the method of ordering digital prints utilizing the function of downloading digital image data of the image input apparatus (6). First, a customer carries out the processing using the image input apparatus (6) installed at a store (10) in a remote place such as a sight seeing place, to produce an index print (71). Next, after returning home, or on the way of returning home, he visits the store (9) near his home, using the image input apparatus (6) installed there, reads out digital image data stored in the laboratory server (16) of the collecting delivering laboratory (18), or in the image server (19) of the service center (20) (29 and 42, or 29 and 44) by inputting the ID number noted in the aforesaid index print (71) and receives it through The Internet (41 and 30 or 43 and 30); then, he stores the digital image data in a medium (63) sold by the image input apparatus (6). It is also appropriate that, successively, by using the monitor (83) provided in the image input apparatus (6), he prepares an order file for digital prints, and after he stores the order file in the aforesaid medium (63), he can make an order directly at the mini-laboratory shop (13) (69).

Further, as shown in FIG. 8, a customer may store digital image data in an medium (63) sold by the image input apparatus (6), or successively, by using the monitor (83) provided in the image input apparatus (6), he may prepare an order file for digital prints, and transmit the order file and the digital image data directly to the collecting delivering laboratory (18) through The Internet (29 and 42), to make it possible to receive the digital prints at his home by mail, home delivery service, or the like (64).

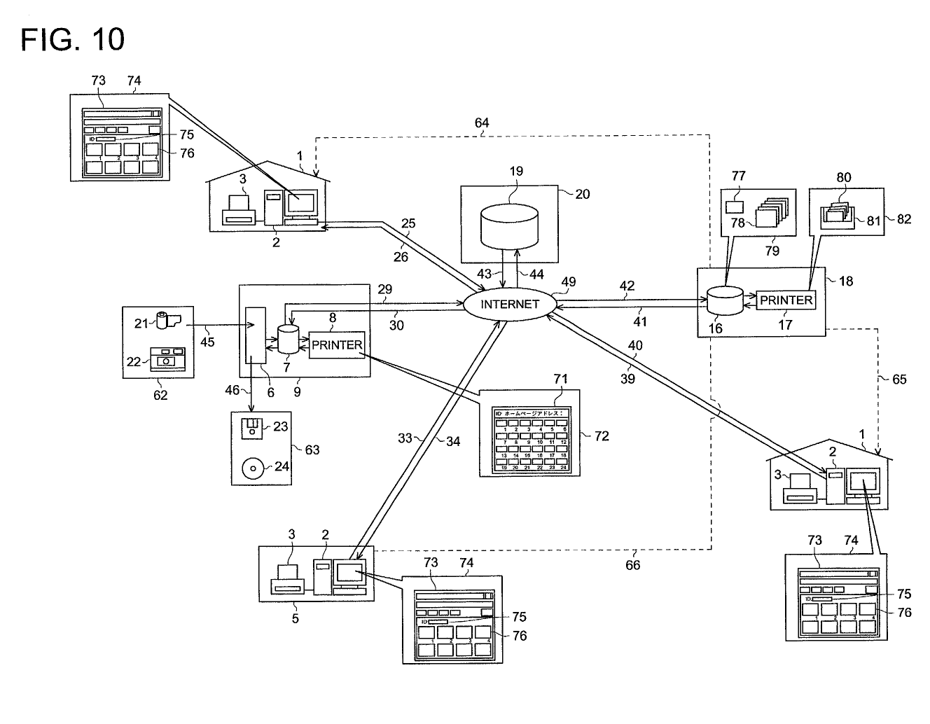

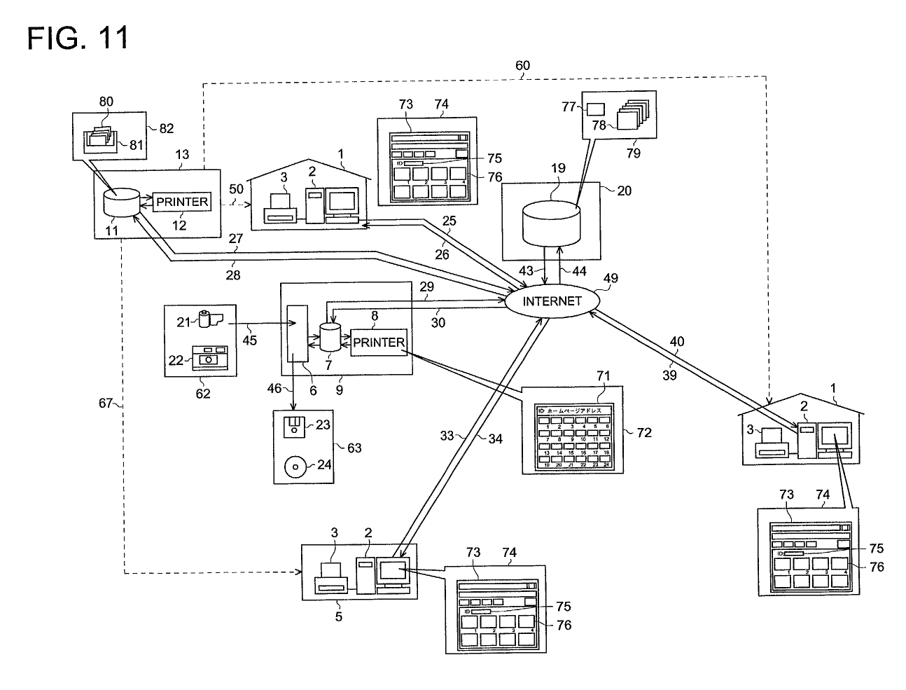

Further, as shown in FIG. 10 and FIG. 11, also in the case where the perusal of digital image data is done by the use of the computer (2) at the home of a customer's friend (4) or at a customer's office (5), by conveying the ID number noted in the index print (71) and the home page address to his friend or to his office orally or by a letter, telephone, fax, an electronic mail, or the like, through designating all or a part of the list of preview images of the digital image data (76) which is displayed on the software (73) by the use of a browser, carrying out the predetermined inputting in a column for noting the delivery destination of the digital prints and a column for designating the way of payment (for example, payment by a credit card, or collect on delivery), and carrying out the transmission operation of data, the order making operation for producing the digital prints of the digital image data is finished.

FIG. 10 shows the case where a collecting delivering laboratory produces digital prints and delivers them to the home of a customer's friend or to a customer's office by mail, home delivery service, or the like, and FIG. 11 shows the case where a mini-laboratory shop does the same thing. It is also appropriate that a customer enters an order in a column for entering an order for digital prints, or a customer himself brings the index print (71), in which the image input apparatus (6) has directly noted an order, to the mini-laboratory shop (13), to produce digital prints.

It is also appropriate that a customer makes an order orally by contacting the telephone number of the service center noted in the index print (71), or a customer makes an order by transmitting an order form, in which an order for digital prints is entered, to the fax number of the service center noted in the index print (71).

In the following, the embodiment of the image input apparatus (6) which is used in a photo-service system of this invention will be described by referring to the drawings.

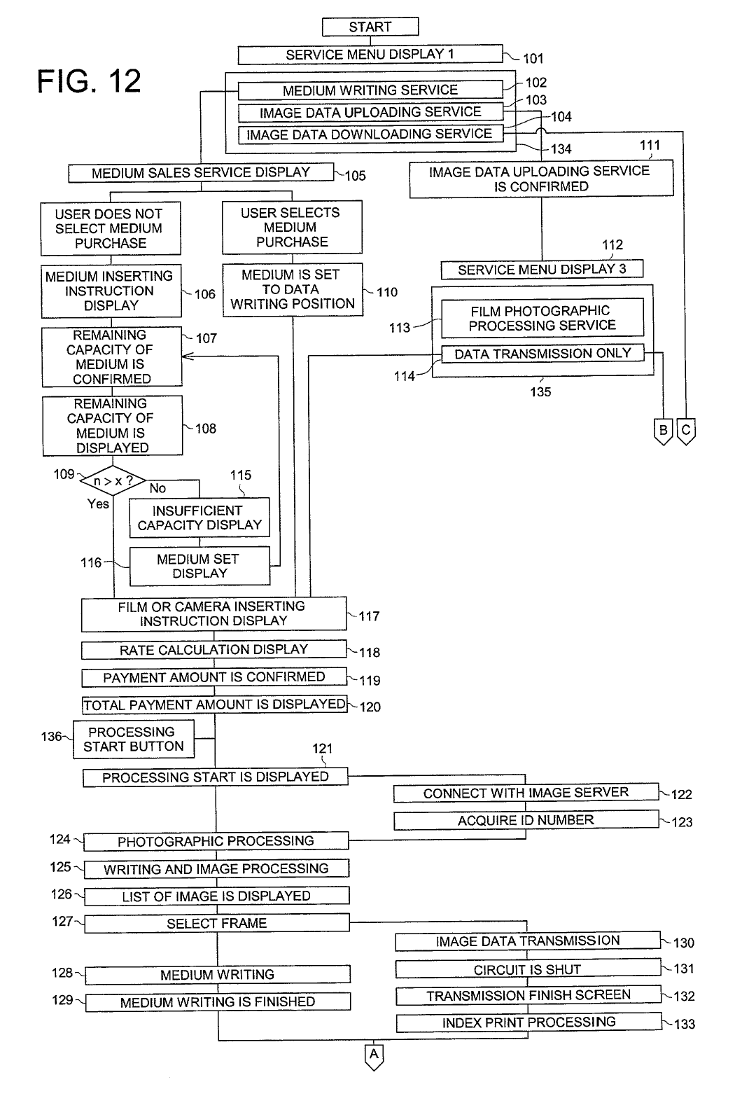

As shown in FIG. 12, for receiving the above-mentioned service, a customer first looks at the service menu screen 1 (101) displayed on the monitor display of the image input apparatus, to select the service of his object.

On the display, a screen for selecting one (134) out of the medium writing service (102), the image data uploading service (103), and the image data downloading service (104). The medium writing service (102) is a menu item to be selected in the case where a customer hopes to record or store digital image data in an external medium capable of being dismounted such as a “CD-R” or an “MO” to bring it back.

The image data uploading service is a menu item in the case where a customer does not hope to bring back the medium, which is different from the above-mentioned medium writing service (102). In this case, digital image data, after temporarily being stored in the server (7) at the store (9 or 10), is transmitted to the server (11, 19, or 16) that is installed at any one of the collecting delivering laboratory (18), the service center (20), and the mini-laboratory shop (13, 14, or 15) through The Internet, to be stored. In the cases where the storage of the aforesaid digital image data is carried out, and where a customer wishes to peruse the digital image data, this menu item is to be selected.

The image data downloading service is a menu item for the case where a customer hopes to store the digital image data, which has been transmitted to the server (11, 19, or 16) that is installed at any one of the collecting delivering laboratory (18), the service center (20), and the mini-laboratory shop (13, 14, or 15) through The Internet and is stored, in an medium capable of being dismounted such as a “CD-R” or an “MO”, and to bring it back. In the case where a customer wishes to download the aforesaid digital image data, he should select this menu item.

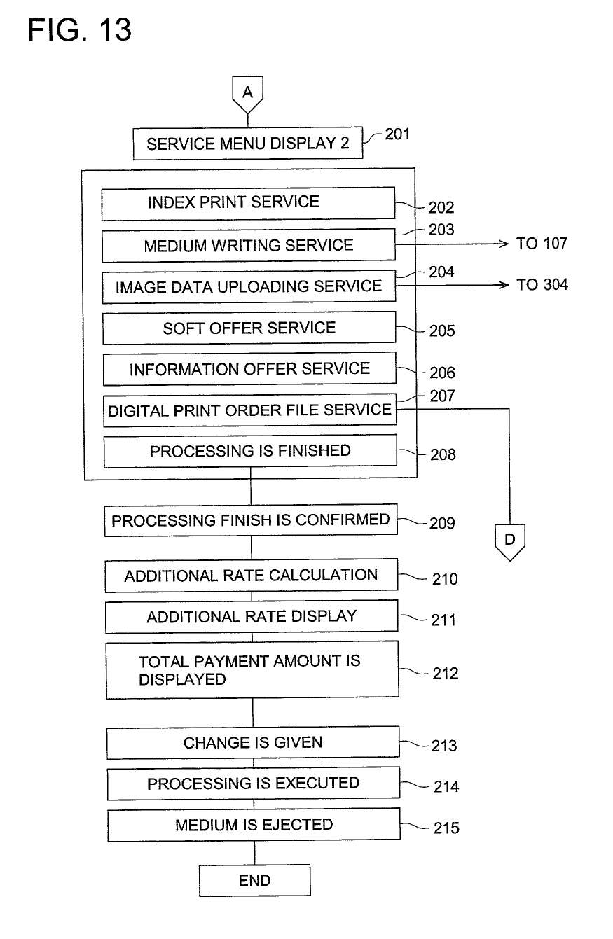

For the case where a customer wishes to order the aforesaid digital prints, the digital print order file producing service (207) is provided in the service menu display 2 in FIG. 13.

In the following, the flow of the processing in the case where the medium writing service (102) has been selected will be described in detail by referring to FIG. 12 and FIG. 13.

The medium selling service screen (105) is displayed on the monitor display, and a customer carries out the selection whether he will buy a medium or not and input. If he requests the sales of a medium, the image input apparatus (6) sets a medium for sales which has been stored beforehand inside the apparatus at a position where writing is possible (110). If a customer does not request the sales of a medium, the image input apparatus displays the screen instructing the insertion of a medium (106) for urging the insertion of a medium on the monitor display.

When a customer sets a medium at a specified position of the image input apparatus (6), it carries out immediately the confirmation of remaining capacity of the medium (107). When the confirmation is finished, the remaining capacity of the medium is displayed on the monitor display (108). At this time, if the remaining capacity of the medium (n) is under the specified capacity (x) (n<x), it carries out the display of insufficient capacity (115) and the ejection of the medium, and displays the set-a-medium screen (116) which urges the customer to set a new medium.

If the remaining capacity of the medium (n) is over the specified capacity (x) (n>x), the image input apparatus displays the screen instructing the insertion of a film or a camera (117) which urges the customer to insert a film or a camera on the monitor display.

The image input apparatus (6) automatically reads the kinds of the inserted film or camera (the name of the manufacturer, the number of frames of the film, the sensitivity, etc.) on the basis of the printed pattern or a bar code information based on the specified standard noted on the film or camera, and carries out the display of the charge (118).

When the customer deposits a money for a part of or all the charge, the display confirming the deposited sum (119) is done, and the image input apparatus makes the final display of the deposited sum for the charge (120), to come in the still-standing state.

When the customer presses the processing start button, the processing start display (121) is done; then, the image input apparatus practices the photographic processing (124) and the reading and image processing (125), and displays the screen of a list of images (26) on the monitor display, to stand still.

Next, a customer is requested to judge if all frames of the list of images (126) displayed on the screen are to be written in the medium, and in accordance with the result of the selection of image frames (127), writing in the medium (128) is carried out. When the writing in the medium is finished, the image input apparatus displays the screen indicating the completion of the writing in the medium (129) on the monitor display, and stands still.

Next, as shown in FIG. 13, the image input apparatus (6) displays the service menu screen 2 (201) on the monitor display.

The index print service (202) is a service to produce a hard copy indicating a list of images, and it is not carried out the description of an ID number, a home page address, the storage period of digital image data, an explanation sentence about automatic erasing, etc., which are noted in the index print (71).

The medium writing service (203) is the same service to be done again; that is, the image input apparatus (6) starts the processing on and after the confirmation of the remaining capacity of the medium (107) in FIG. 12.

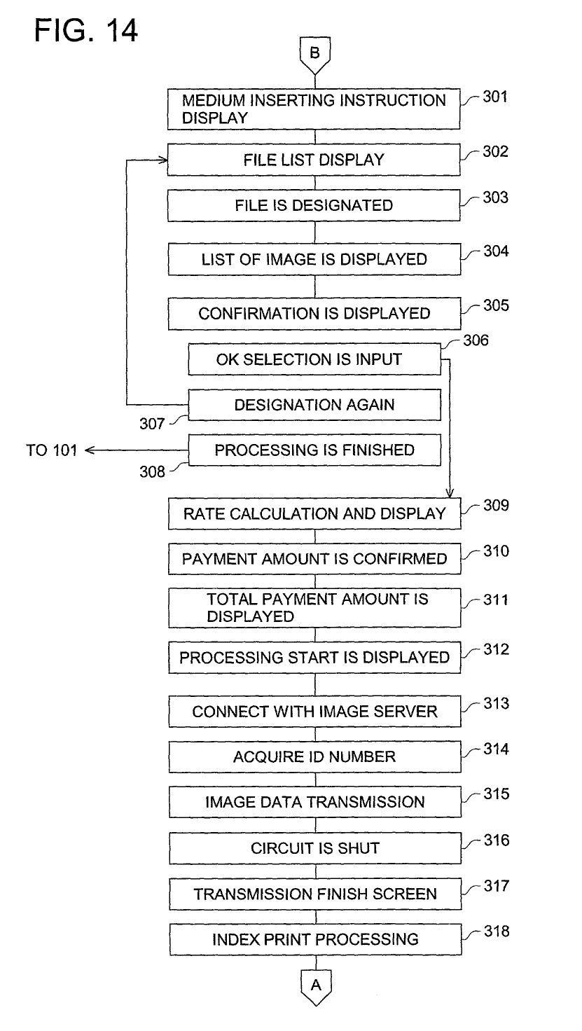

The image data uploading service (204) is a service to do the image data uploading service (103) in the service menu screen 1 (101) additionally for the digital image data which has been written in the medium in the medium writing service (102). The image input apparatus starts the processing on and after the display of a list of images (304) in FIG. 14. In addition, with respect to the image data uploading service (103), the detail will be described later.

The software providing service (205) is a service to store a program for use in making an order for digital prints described in FIG. 5 and FIG. 6 in an medium. The above-mentioned program is used in making an order for digital prints by using the computer (2) at a customer's home (1), and has a function to make communication automatically without the manual input of an ID and a home page address noted in the index print (71), a display function to use simultaneously also the digital image data stored in the medium (63), etc.

The information providing service (206) is a service to provide various kinds of pieces of information principally by the manufacturer and the laboratories.

It is carried out after the payment of the charge, the practice of processing in the case where it is selected any one of the above-mentioned services, namely, the index print service (202), the software providing service (205), the information providing service (206), and the digital print order file producing service (207). Accordingly, after the selection of a service, the processing is finished (208), and the screen confirming the completion of processing (209) is displayed on the monitor display; then, through the calculation of the additional charge (210), the display of the additional charge (211), the display of the deposited sum of charge (212), the payment of the changes (213), the practice of processing (214), and the ejection of the medium (215), the processing is finished.

If the processing finished (208) is selected, the screen confirming the completion of processing (209) is displayed on the monitor display, and through the calculation of the additional charge (210), the display of the additional charge (211), the display of the deposited sum of charge (212), the payment of the changes (213), and the ejection of the medium, the processing is finished.

In the following, the flow of the processing in the case where the image data uploading service (103) is selected will be described in detail by referring to FIG. 12, FIG. 13, and FIG. 14.

First, the display confirming the image data uploading service (111) is done and the service menu screen 3 (112) is displayed on the monitor display.

When the film photographic processing service (113) is selected, the routine from the display of the medium sales service (105) to the display of the instruction of inserting a film or camera (117), which is to be processed in the case where the medium writing service is selected, is omitted, and the procedure after the above-mentioned display of the instruction of inserting a film or camera is started.

Further, in the case where the image data uploading service (103) is selected, the point that is greatly different from the case where the medium writing service is selected, is that the image input apparatus carries out the processing to acquire an ID number (123) through the connection to the image server after the display of the start of procedure (121).

Furthermore, in the case where the image data uploading service (103) is selected, the routine consisting of the medium writing (128) and the display of the completion of medium writing (129), which is practiced in the case where the medium writing service (102) is selected, is omitted, and the routine consisting of the transmission of image data (130), the cut-off of the line (131), the display of the completion of the transmission (132), and the processing of index print (133) is carried out in place of that. Moreover, in the index print which is produced by the above-mentioned processing of index print (133), it is done the description of an ID number, a home page address, the storage period of digital image data, an explanation sentence of automatic erasing, etc. After that, the routine is the same as the procedure in the case where the medium writing service (102) is selected, but the procedure is finished without practicing the ejection of the medium (215).

In the following, it will be described the procedure in the case where only the data transfer (114) is selected in the service menu screen 3 (112) shown in FIG. 12.

As shown in FIG. 14, first the screen instructing the insertion of a medium (301) is displayed on the monitor display. When a customer sets a medium at the specified position, the display of a list of files (302) is immediately done, and the image input apparatus stands still in the state ready for the operation of the designation of a file (303) by the customer.

Next, when the operation of the designation of a file is finished, the images in the file which has been designated by the customer are displayed in the step of the display of a list of images (304).

In the step of the confirmation display (105), if no error is found, by the input of the customer selecting the OK (306), the procedure proceeds to the calculation and display of charge (309). If the designation again (307) is selected, the procedure returns to the display of a list of files again. If the processing finished (308) is selected, the procedure returns to the service menu screen 1 (101) in FIG. 12.

As shown in FIG. 14, the procedure on and after the calculation and display of charge (309) is practiced in the case where the film photographic processing service (113) is selected. The steps up to the index print processing (133) in which the routine from the photographic processing (124) to the selection of image frames (127) is omitted in FIG. 12 are carried out, and the procedure moves to the steps on and after the service menu screen 2 (201) in FIG. 13.

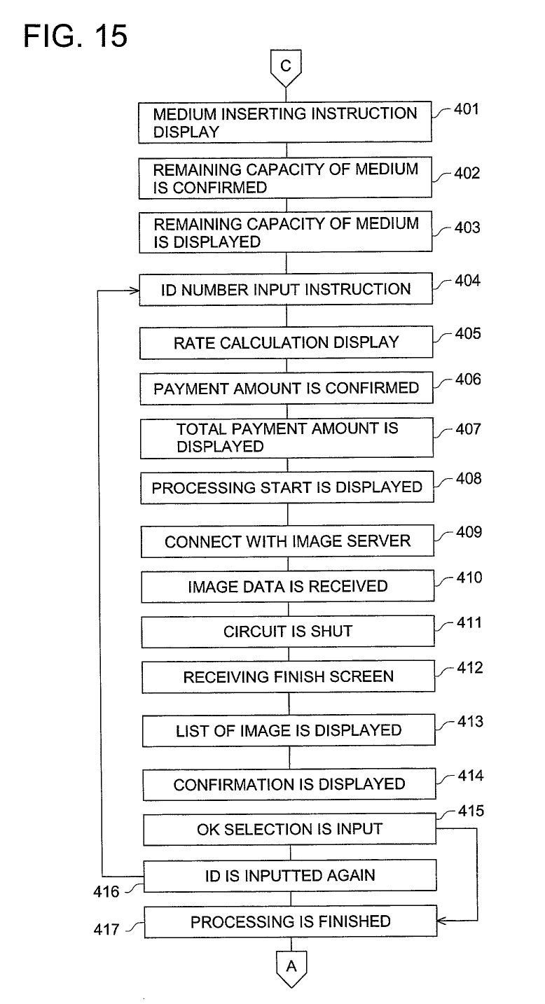

In the following, it will be described the flow of the processing in the case where the image data down loading service (104) is selected by referring to FIG. 12 and FIG. 15.

When a customer selects the image data downloading service (104) in the service menu screen 1 (101), as shown in FIG. 15, the screen instructing the insertion of a medium (401) is displayed on the monitor display. When the confirmation of the remaining capacity of the medium (402) and the display (403) are finished, successively the display of the instruction of inputting an ID number (404) is done.

Next, the image input apparatus (6), after finishing the routine for charge payment (405 to 407), practices the routine (409 to 413) from the connection to the image server to the display of a list of images of the image data acquired.

In the step of the confirmation display (414), if the customer selects the OK (415), the image input apparatus, after doing the display of the processing finished (417), starts the procedure on and after the service menu screen 2 (201).

If the input of an ID again (416) is selected, the procedure returns to the display of the instruction of inputting an ID number (404), in order to carry out the image data downloading service again.

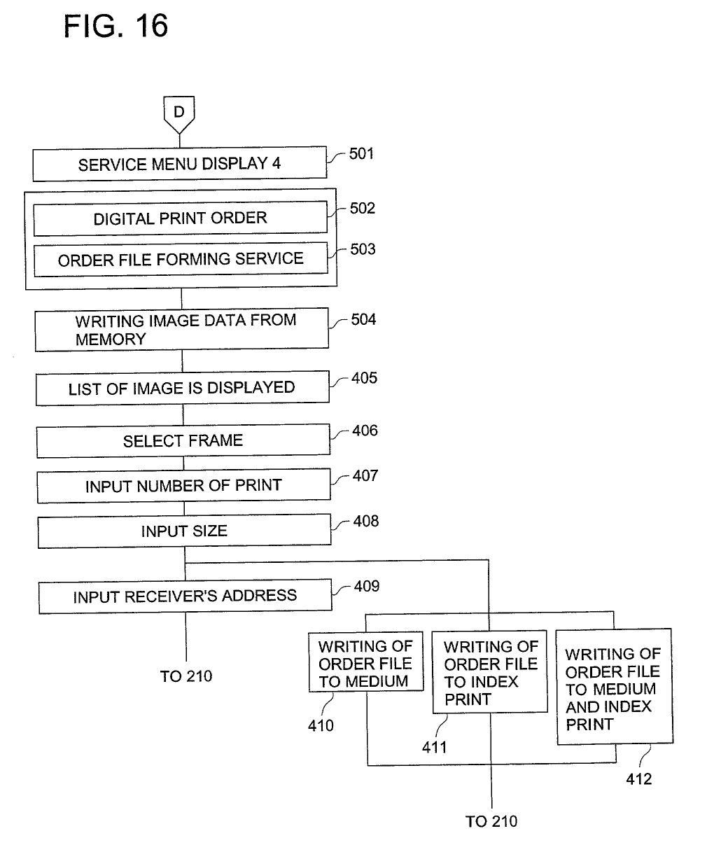

In the following, it will be described the flow of the processing of the digital print order file producing service by referring to FIG. 13 and FIG. 16.

When a customer selects the digital print order file producing service (207) in the service menu screen 2 (201) shown in FIG. 13, the service menu screen 4 (501) shown in FIG. 16 is displayed.

The order for digital prints (502) is a service to deliver digital prints produced by a laboratory in accordance with an order file, which is prepared by a customer and transmitted by the image input apparatus (6) directly to the laboratory through The Internet (49), to the customer by mail or home delivery service.

The order file preparing service (503) is a service done by the image input apparatus storing an order file prepared by a customer in a medium. The medium, in which the order file is stored, is brought by the customer himself to a mini-laboratory shop, and the mini-laboratory shop, having received the medium, produces digital prints in accordance with the order file stored in the medium.

When a customer selects the order for digital prints (502), the image input apparatus (6) reads out digital image data stored temporarily in an internal memory medium in the step of the readout of image data from a memory (504) shown in FIG. 16.

The customer, as looking at the images displayed on the monitor display in the step of the display of a list of images (505), carries out the selection of image frames to produce digital prints (506), the input of the number of prints (507), the input of size (508), and the input of delivery destination (509). Next, the customer selects and inputs any one out of the writing of the order file in the medium (510), the writing of the order data in the index print (511), the writing of the order file in the medium and the writing of the order data in the index print (512). After that, the procedure moves to the calculation of the additional charge shown in FIG. 13. Moreover, in the step of the practice of processing (214), the order file is transmitted to a laboratory, and the digital image data stored in the internal memory medium is automatically erased after that.

When a customer selects the order for digital prints (503), the image input apparatus (6) reads out digital image data stored temporarily in an internal memory medium in the step of the readout of image data from a memory (504) shown in FIG. 16.

The customer, as looking at the images displayed on the monitor display in the step of the display of a list of images (505), carries out the selection of image frames to produce digital prints (506), the input of the number of prints (507), the input of size (508). After that, the procedure moves to the calculation of the additional charge shown in FIG. 13. Moreover, in the step of the practice of processing (214), the order file is stored in a medium, and the digital image data stored in the internal memory medium is automatically erased after that.

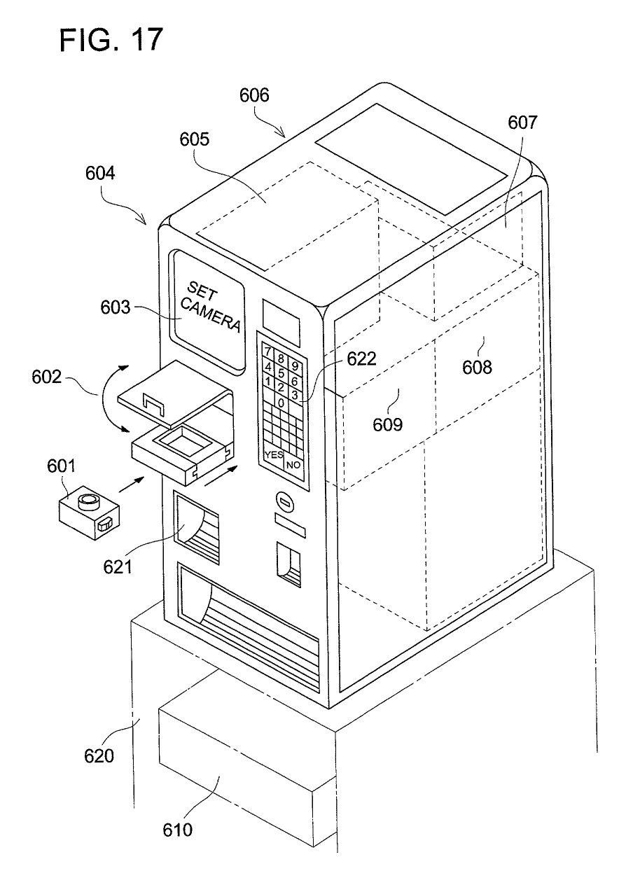

Next, an example of practice of an image input apparatus which can be used desirably in this invention will be explained by referring to FIG. 17. This example of practice is an automatic processing A/D converting apparatus for a photograph taking unit (hereinafter referred to simply as a taking unit) based on a silver halide photographic film, which is of small size, simple in the control of maintenance and operation, of low price, and excellent in safety.

This automatic processing A/D converting apparatus for a silver halide photographic film (hereinafter sometimes referred to as a photosensitive material) is characterized by the following points: (1) it is provided with a receiving unit for receiving a taking unit after having finished taking a photograph, said taking unit having a sheet-shaped or circular plate-shaped silver halide photographic film loaded beforehand in the state capable of taking a photograph, a thermal photographic-processing unit for thermally processing the silver halide photographic film loaded in said taking unit, an A/D converting recording unit for converting the analogue image information obtained by processing into digital image information and recording it, and an operation unit; (2) digital image information can be recorded in any one or more of an external memory medium (for example, CR-ROM, MD etc.) which can be stored in or removed from the automatic processing A/D converting apparatus, a memory medium which is fixed to or outside the automatic processing A/D converting apparatus, and an image server which can be communicated with the automatic processing A/D converting apparatus through the Internet; (3) a printer unit is built in.

In the following, detailed explanation will be given.

In FIG. 17, the apparatus 606 for carrying out the thermal processing, A/D conversion, and recording of the silver halide photographic film contained in the taking unit 601 is composed of the photographic processing unit 609, the A/D conversion recording unit 608, the external memory medium supplying unit 607, and the operation unit 604, and desirably, it is provided with the printer unit 610 as an option; further, it has an image database unit to which digital image data is transmitted through an electrical communication means connected to it.

In addition, in order to make an apparatus of this invention an unmanned apparatus not requiring a dedicated operator, a payment unit for receiving a necessary charge is arranged. In the case where this apparatus is installed in each of plural stores such as so called convenience stores, the way of receiving a charge can be made such one as to do it at a checkout counter.

In the following, the structure of each of units will be explained.

The photosensitive material receiving unit 602 is a unit for receiving the taking unit 601, which a user has brought in the automatic processing-A/D converting-recording unit 606, and is provided with a mechanism for setting the taking unit 601, a mechanism for recognizing the taking unit 601, and a mechanism for taking out a silver halide photographic film from the taking unit 601.

First, the mechanism for setting the taking unit 601 and the mechanism for recognition will be explained.

The entrance of the photosensitive film receiving unit 602 is covered with a cover for shading, and when an operation to open the cover etc. are carried out by a user, the base for setting the taking unit 601 operates to project, and such an instruction as “Please set a taking unit” for example by voice or letters is made. When the user sets the taking unit 601 at the concave portion prepared in the base, and the base is received in the inside through the receiving operation by the user or automatically by it self.

At this point of time, the recognition of the shape of the taking unit 601 is done, or in other words, it is judged by reading a bar code displayed on the outer surface of the taking unit 601, if the taking unit 601 is an object capable of being processed, and if it can be received, such an instruction as “Please shut the shading cover.” for example by voice or by letters is made; then, when the closing and fixing of the shading cover is confirmed by a sensor, such an instruction as “Receiving is finished. Please designate the service to provide.” by voice or by letters is made. If the taking unit 601 which has been set is recognized as an object incapable of being received, such an instruction as “Please set it again.” or “We are sorry, but this kind of taking unit can't be processed. Please remove it.” by voice or by letters is made. It may be appropriate, in this case, to prepare a mechanism for automatically ejecting the taking unit 601 having been set from the setting position.

In order to carry out the recognition of the difference of the outer shape of the taking unit 601, for example, a particular concavo-convex shape corresponding to the outer shape of the taking unit 601 concerned is formed at the position for setting the taking unit 601, for example. By making such a structure, also the setting direction or the position of the taking unit 601 can be determined.

In order to make it possible to receive the taking unit 601 quickly and correctly, it is desirable to display an illustration about how to receive it on the front surface of the shading cover or on the front surface of the wall exposed by opening the shading cover, or further, on a display screen or the like.

The taking unit 601 to be received by an apparatus of this invention is loaded with a silver halide photographic film of a thermal processing type. A film of a thermal processing type, as compared to one of a liquid processing type which is generally widely used, is capable of simplifying the mechanism of the photographic processing unit 609 very much owing to the non-use of a photographic processing liquid, and has the advantage that the load for the replenishment and collection of the processing liquid, the control of temperature, and the maintenance of the unit is lightened.

It will be omitted the detailed explanation about how to obtain a silver halide photographic film of a thermal processing type, because it is not a constraining factor of this invention; however, Japanese publications of the unexamined patent applications H9-204031, H9-258402, H9-274295, H9-121265, H9-146247, and H9-230557, for example can be referred to.

Next, to characterize the silver halide photographic film loaded in the taking unit 601 by its shape, it has a shape of a sheet or a circular disk. For the taking unit 601 of such a type, for example, those which are described in the Japanese publications of the unexamined patent applications H10-158427, H10-170624, H10-338983, H10-366798, H11-102454, etc. can be cited.

Next, the photosensitive material receiving unit 602 is provided with mechanisms for automatically taking out the silver halide photographic film having a shape of a sheet or a circular disk loaded in the taking unit 601, and conveying it out to the photographic processing unit 609.

The concrete structure of the mechanism for taking out the film from the taking unit 601, and the mechanism for conveying it out to the photographic processing unit 609 is associated with the concrete structure of the taking unit 601. That is, there is a large difference in the mechanism between the cases where the taking unit 601 itself is provided with a mechanism for ejecting the film loaded inside to the outside, and where it is not provided with the mechanism.

For example, as disclosed in the Japanese publication of the examined utility model application H7-31228, in the case where the taking unit 601 itself is provided with a mechanism for ejecting (taking out) the film, there is provided a mechanism for operating said ejection (take-out) mechanism in the photosensitive material receiving unit 602 side.

Next, it will be explained the case where the taking unit 601 itself is not provided with a mechanism for ejecting (taking out) the film. In order to take out a film from the taking unit 601 of such a type, it is required a mechanism for destroying the housing of the taking unit 601 or for opening the housing and taking out the loaded film.

The photographic processing unit 609 will now be explained.

This unit is for thermally processing a silver halide photographic film having a shape of a sheet or a circular disk, which has been taken out from the taking unit 601 or still remains in the state of being loaded in the taking unit 601.

In an apparatus of this invention, for the method of thermal processing, various methods such as one utilizing a heat block (electric heating plate) or one utilizing a microwave can be employed.

In the method of utilizing an electric heating plate, in order to shorten the service providing time, it is desirable to carry out the preceding (preliminary) heating of the electric heating plate prior to the start of thermal photographic processing. The timing to start the preceding heating of the electric heating plate can be set arbitrarily in such a timing that the presence of a user is recognized by a sensor provided at the front surface of the apparatus, or that the setting by the photosensitive material receiving unit 602 is started or finished, for example.

Because the inside of the photographic processing unit 609 is heated, it is necessary to insulate this heat in order that it may not give a bad effect to a user or the devices in other parts of the apparatus. For the photographic processing unit of such a type, the Japanese publications of the unexamined patent applications H11-352661, 2000-292895, etc. can be referred to.

Now, the A/D converting recording unit 609 will be explained.

This unit is one for making the visualized image of the film, for which the photographic processing has been finished, a digital signal by scanning it with a transmitting light, and recording the obtained digital image information.

The recording of digital image information is done for any one of the following: an external memory medium which can be taken out to the outside and provided to a user, an internal recording medium which an apparatus itself of this invention comprises inside, and an image database for which transmission and recording of image information are made through a communication means.

There is no particular restriction for the external memory medium that can be utilized.

For the external memory medium, it may be utilized in a mode to prepare a single kind of it, or it may be utilized in a mode to prepare plural kinds of it in order that a user may select any one of them; it is prepared in the external memory medium supplying unit 607.

The external memory medium having digital image information recorded is ejected from the ejection opening and given to the user.

The film, of which image information has been recorded in an external memory medium and processing has been finished, is ejected from the ejection opening and returned to the user. To adopt a mode in which the film is returned to the user is done for the reason to eliminate a concern that he may have about being used by stealth. Accordingly, in the case where this apparatus is provided with a mechanism for destroying the film for which processing has been finished by such a method as cutting or the like, and the user gives a consent to such a processing, it is possible to adopt a mode in which the film for which processing has been finished is not returned to the user. The confirmation of this consent of the user can be carried out in a dialogue form by using the operation unit 604 to be described later.

The printer unit 610 is provided as an option; it reads out image information recorded in any one of an external memory medium, an internal recording medium, and an image database, displays the image on a monitor screen, and prints various kinds of single-frame prints or an index print.

Further, an image database unit is provided as an option. This unit is one for electronically transmitting, after obtaining the consent of the user, the same digital image information as that recorded in the external memory medium to an image database which is arranged at another place and recording it in the database.

Now, the operation unit 604 will be explained.

This unit is composed of an operation board, the monitor display 603, and the control unit 605, and is one for practicing the guide of the kinds of services provided by this apparatus, the selection of a service, etc. In addition, it may be appropriate to make this operation unit 604 have a structure such that it can be utilized also for the operation of the printer unit 610 which is provided as an option or the access to the image database unit.

An example of the operation by the operation unit 604 will be explained.

When a user sits on a chair or the like provided in front of the apparatus, a sensor detects it to actuate the apparatus automatically. At this time, in the case where thermal processing is one of a type to utilize an electric heating plate, an electric current is made to flow in the electric heating panel to carry out the preceding heating. In addition, in order to prevent the actuation of the apparatus by a piece of mischief, it is also possible to make the structure such one that the apparatus is actuated not automatically but when a user has turned on the actuating switch.

When the apparatus is actuated, the kinds of services to be provided are displayed for guide on the monitor display 603. The guidance display of the services is carried out in such a way as “Photographic-processing and A/D conversion processing”, “Photographic-processing and A/D conversion processing+Index print”, “Photographic-processing and A/D conversion processing+Index print+Print”, “Photographic-processing and A/D conversion processing+Index print+Image information control”, “Photographic-processing and A/D conversion processing+Index print+Print+image information control”, etc., and when the selection by a user is made, the screen for confirming the kind of the service is displayed. In addition, the selection by a user is made by the method of inputting using the keyboard 622, or the method of touching the monitor screen, for example.

After the display of the screen for confirming the kind of the service, the display is switched to the screen for selecting an external memory medium corresponding to the service designated, a print size, etc. In the screen for selecting an external memory medium, recording media that can be utilized as well as the prices are displayed. Also in the screen for selecting a print size likewise, print sizes that can be utilized as well as the prices corresponding to the number of prints are displayed. The kind of the external memory medium as well as its price and the print size as well as the price corresponding to the number of prints which have been selected are displayed, and confirmation by the user is requested.

In a certain step among the above-mentioned operations, it is requested for a user to confirm if the film for which processing has been finished needs to be returned.

When the selection of the kind of the recording medium to utilize, the print size, etc. is confirmed by the user, on the monitor display 603, “Please open the cover and set a taking unit at the specified position.” is displayed, and in a desirable mode, an illustration about how to set a taking unit is displayed on the screen. When the setting of a taking unit by the user is finished, whether said taking unit is of a type capable of being received or not is confirmed, and if it is one that can not be received, a sentence to that effect is displayed on the screen (notification by voice or by both may be used), and the ejection of the taking unit is requested. In addition, in order to eliminate the loss of time, it is desirable to make the structure such one that, prior to the selection of the service etc. by the monitor screen, the recognition operation whether the taking unit is capable of being received or not is carried out.

When it is detected that the taking unit which has been set is capable of being received, and the setting position is correct, after further confirmation of the closing of the shading cover, on the monitor screen, such displays as “Operation starts.”, “It takes about xx minutes for finishing the service.” etc. are made, and in order to get rid of boredom during the waiting time, desirably, for example, explanations of the operation step such as “Now, the film is being taken out.” and “Now, A/D conversion is being done.” are displayed. Further, in a more desirable mode, in addition to the screens indicating the operational step, a screen showing some intelligence about photography or a commercial of a new apparatus, a melody of a latest hit song, a moving image, or a hit chart is displayed and/or sounded. In a further mode, a service of receiving and recording the digital information on songs which are lately very popular is carried out by online communication. That the apparatus is provided with such multiplex functions makes higher the ratio of service charge income to the apparatus installing area, and it is effective also for making higher the demand for the installation of the apparatus. Further, with an apparatus of this type, it is possible to cooperate with traders in the business world of musical media, which is effective to lower the expense of the installation and maintenance of apparatus.

In addition, at the step when the confirmation of the receiving of the taking unit and kind of the service has been finished, the charge for the service is shown and request for payment and the confirmation of receipt are carried out.

When A/D conversion and recording has been finished, desirably, after it has been confirmed that the recording is perfect, the film for which processing has been finished and the external memory medium are ejected to the outside of the apparatus, and the confirmation of the reception of them by the user is carried out.

When the whole service process has been finished, on the monitor display, for example, “All service has been finished. Please confirm it.” is displayed, and if the user makes the confirmation button on, the whole service process has been completed.

According to this invention, the above-mentioned problems 1 to 3 can be solved, and by combining an image input apparatus of a self-service (unmanned) type, which photographic-processes an exposed color negative film and converts the visualized image recording information into digital image data through an image sensor, with a network, it is possible to build up a photo-service system and an image input apparatus for providing a multiplex photographic service which is composed of a service to keep digital image data, a service for perusing digital image data, a service to provide digital image data, and a service to receive an order for digital prints.

What is claimed is:

1. A photographic service system comprising:
(a) at least one or more of an image input apparatus comprising
(1) means for receiving an order by itself without a dedicated operator,
(2) means for photographic-processing a silver halide photographic light-sensitive material,
(3) means for converting image recording information of the silver halide photographic light-sensitive material after the photographic processing into digital image data through an image sensor, and
(4) means for issuing an ID for retrieving digital image data and an index print after receiving the order; and
(b) an image server comprising
(1) means for communicating with the image input apparatus through a network and
(2) means for giving the ID for retrieving digital image data to the digital image data transferred from the image input apparatus and for storing the digital image data.

2. The photographic service system of claim 1, wherein at least one of the image input apparatus comprises:
means for capturing the digital image data from the image server by inputting the ID for retrieving; and
means for storing the captured image data in a detachable external memory medium.

3. The photographic service system of claim 1, further comprising a client computer having means for communicating with the image server through a network, wherein the image input apparatus comprises
means for issuing, after receiving the order, a home page address, an ID for retrieving digital image data and an index print, and the client computer further comprises,
means for enabling an operator to read the digital data by inputting the ID for retrieving digital image data while the client computer is communicated with the image server through the network, and
means for storing the digital image data into a memory medium of the client computer.

4. The photographic service system of claim 1, wherein the image input apparatus comprises:
means for receiving an order for producing a digital print;
means for issuing, after receiving an order, an ID for retrieving digital image data;
means for preparing an order data file in which the content of the order for the digital print and the ID for retrieving are recorded;
means for transferring the order data file in the state of being separated from digital image data to the image server;
means for reading out the order data file and digital image data from the image server on the basis of the ID for retrieving recorded in the order data file; and
means for producing a digital print on the basis of the order data file.

5. The photographic service system of claim 1, further comprising means for producing a digital print from the digital image data stored in the image server,
wherein the image input apparatus comprises means for issuing an order form with an index print attached in which a column to be filled with an order for the digital print and an ID for retrieving digital image data are described.

6. The photographic service system of claim 1, wherein the image input apparatus comprises means for issuing an order form with an index print attached in which a column to be filled with an order for a digital print, an ID for retrieving digital image data, and at least one of a telephone number and a facsimile number are described.

7. The photographic service system of claim 1, further comprising means for producing a digital print from digital image data stored in the image server,
wherein the image input apparatus comprises means for issuing an order form with an index print and an ID for retrieving digital image data attached in which an order for producing the digital print is described.

8. The photographic service system of claim 3, wherein the client computer is further able to make an order for producing a digital print.

9. The photographic service system of claim 1, wherein at least two or more of the image input apparatus are provided.

10. An image input apparatus comprising means for receiving an order by itself (without a dedicated operator), means for photographic-processing a silver halide photographic light-sensitive material, means for converting image recording information of the silver halide photographic light-sensitive material after the photographic processing into digital image data through an image sensor, and means for issuing a specified form in which an ID for retrieving a digital image is described.

11. The image input apparatus of claim 10, further comprising means for issuing a specified form in which a home page address in addition to the ID for retrieving a digital image is described.

12. The image input apparatus of claim 11, further comprising means for issuing a specified form in which a index print in addition to the ID for retrieving a digital image and the home page address is described.

13. The image input apparatus of claim 12, wherein the specified form has a magnetic layer for recording information, and order data is recorded in the magnetic recording layer.
